(19) United States
(12) Patent Application Publication
(10) Pub. No.: US 2017/0183161 A1
(43) Pub. Date: Jun. 29, 2017

(54) AUTOMATIC ROLLER SHAFT TRANSMISSION DEVICE

(71) Applicant: Guangdong Oufulong Automatic Shelf Technology Co., Ltd., Zhuhai (CN)

(72) Inventor: Fei Tong, Zhuhai (CN)

(21) Appl. No.: 15/220,450

(22) Filed: Jul. 27, 2016

(30) Foreign Application Priority Data
Dec. 29, 2015 (CN) 201521130970.X

(51) Int. Cl. B65G 13/11

(52) U.S. Cl. CPC B65G 13/11

(57) ABSTRACT

The disclosure relates to a novel automatic roller shaft transmission device, which comprises a roller shaft seat and a plurality of roller shafts; the roller shaft seat comprises a roller shaft mounting base, front and rear tips and left and right side covers, a roller shaft mounting cavity is formed in an upper surface of the roller shaft mounting base, and the roller shafts are mounted in the roller shaft mounting cavity in a rotating manner; the front and rear tips are arranged at front and rear ends of the roller shaft mounting base respectively, at least one tip forms a split structure with the roller shaft mounting base, a stamping mounting groove is formed in its bottom surface, and the side covers are provided with stamping connecting parts.

### CROSS-REFERENCE TO RELATED APPLICATIONS

The present application claims the benefit of Chinese Utility Model Application No. 201521130970.X filed on Dec. 29, 2015, the contents of which are hereby incorporated by reference.

### TECHNICAL FIELD

The disclosure belongs to the technical field of conveying platforms, and particularly relates to a novel automatic roller shaft transmission device.

### BACKGROUND

At present, roller shaft conveying devices are widely applied to equipment for conveying goods; and each of these roller shaft conveying devices comprises a roller is shaft seat and a plurality of roller shafts, roller shaft mounting cavities are formed in upper surfaces of the roller shaft seats, and the roller shafts are mounted in the roller shaft mounting cavities. However, roller shaft mounting bases and front and rear tips of these roller shaft seats are integrally formed in an injection molding manner, and are high in machining difficulty and scrap rate, so that machining cost is increased.

### SUMMARY

In order to solve the technical problem of a conventional art, the disclosure provides a novel automatic roller shaft transmission device, which is low in machining difficulty, ingenious in structure, easy to assemble and high in efficiency and comprises a few assembly parts and components.

In order to solve the technical problem, the disclosure is implemented by the following technical solution.

A novel automatic roller shaft transmission device is provided, which may comprise a roller shaft seat and a plurality of roller shafts; a roller shaft mounting cavity may be formed in an upper surface of the roller shaft seat, the roller shafts may be mounted in the roller shaft mounting cavity in a rotating manner, bearing recesses may be formed in a sidewall, corresponding to left and right ends of each roller shaft, of the roller shaft mounting cavity, and rotating shafts at the left and right ends of the roller shafts may be movably mounted in the bearing recesses; the roller shaft seat may comprise a roller shaft mounting base, front and rear tips and left and right side covers, the roller shaft mounting cavity may be formed in an upper surface of the roller shaft mounting base, the front and rear tips may be arranged at front and rear ends of the roller shaft mounting base respectively, at least one tip may form a split structure with the roller shaft mounting base, a stamping mounting groove may be formed in its bottom surface, and stamping connecting parts may be arranged at corresponding positions of the side covers; and during assembling, the left and right side covers may buckle left and right sides of the roller shaft mounting base and the tip of the split structure respectively, and the stamping connecting parts may be mounted in the stamping mounting groove, and may be fixedly stamped together.

Furthermore, both the front and rear tips may form a split structure with the roller shaft mounting base, and stamping mounting grooves may be formed in their bottom surfaces; correspondingly, the stamping connecting parts may be arranged on bottom is side edges of front and rear ends of the side covers; and during assembling, the left and right side covers may buckle the left and right sides of the roller shaft mounting base and the two tips, and the stamping connecting parts at their front and rear ends may be mounted in the stamping mounting grooves of the front and rear tips respectively, and may be fixedly stamped together.

Furthermore, the stamping connecting parts may be flaky, and may horizontally extend after being upwards bent.

Furthermore, the side covers may be metal covers, and the stamping connecting parts and the side covers may be integrally formed in a punching manner.

The disclosure has beneficial effects as follows:

by the technical solution of the disclosure, machining difficulty of the roller shaft seat may be greatly lowered; and meanwhile, the roller shaft mounting base is fixedly stamped with the tips of the split structure through the side covers, so that the device is ingenious in structure, easier to assemble and higher in efficiency, more assembly parts and components may be saved, production cost may also be lowered, a greater advantage in market competitiveness may be achieved, and a commercial success may be easier to achieve.

### BRIEF DESCRIPTION OF THE DRAWINGS

The disclosure will be further described below with reference to the drawings and a specific embodiment:

FIG. 1 is an exploded structure diagram of a novel automatic roller shaft transmission device embodiment according to the disclosure;

FIG. 2 is a structure diagram of a side cover in a novel automatic roller shaft transmission device embodiment according to the disclosure; and

FIG. 3 is a local structure diagram of a bottom surface of a novel automatic roller shaft transmission device embodiment according to the disclosure.

### DETAILED DESCRIPTION

In order to make a purpose, technical solution and advantages of the disclosure more clearly, the disclosure will be further described below with reference to the drawings and the embodiment in detail. It should be understood that the specific embodiment described here is only adopted to explain the disclosure and not intended to limit the disclosure.

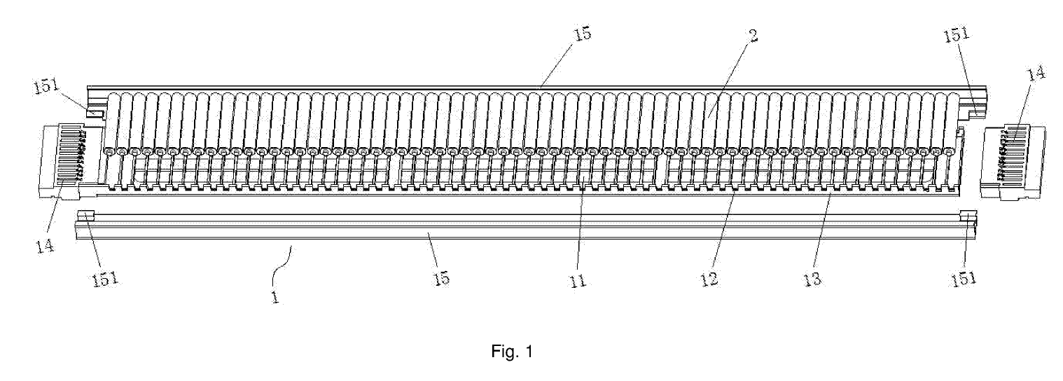

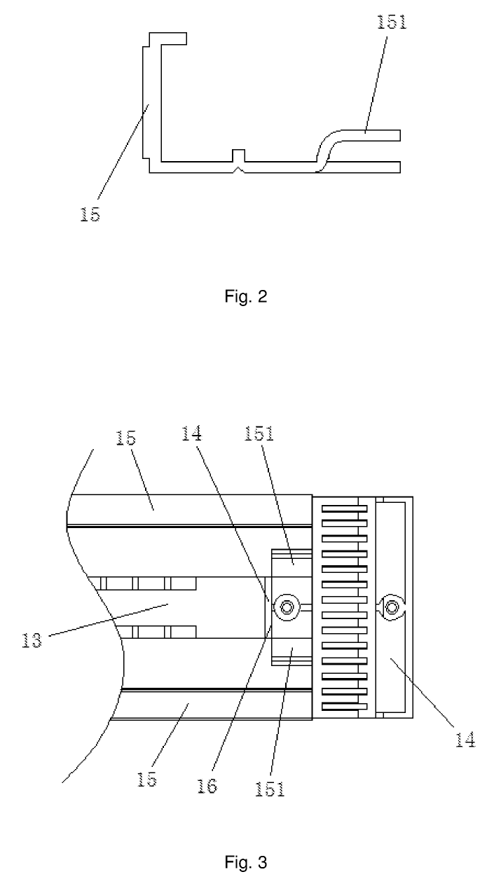

As shown in FIG. 1 to FIG. 3:

a novel automatic roller shaft transmission device of the embodiment of the disclosure comprises a roller shaft 1 and a plurality of roller shafts 2; a roller shaft mounting cavity 11 is formed in an upper surface of the roller shaft seat 1, the roller shafts 2 are mounted in the roller shaft mounting cavity 11 in a rotating manner, bearing recesses 12 are formed in a sidewall, corresponding to left and right ends of each roller shaft 2, of the roller shaft mounting cavity 11, and rotating shafts 21 at the left and right ends of the roller shafts 2 are movably mounted in the bearing recesses 12, wherein the roller shaft seat 1 comprises a roller shaft mounting base 13, front and rear tips 14 and left and right side covers 15, the roller shaft mounting cavity 11 is formed in an upper surface of the roller shaft mounting base 13, the front and rear tips 14 are arranged at front and rear ends of the roller shaft mounting base 13 respectively, one tip 14 forms a split structure with the roller shaft mounting base 13, a stamping mounting groove 16 is formed in its bottom surface, and the other tip and the roller shaft mounting base 13 are integrally formed; stamping connecting parts 151 are arranged at corresponding positions of the side covers 15, the stamping connecting parts 151 are flaky, and horizontally extend after being upwards bent, the side covers 15 may be metal covers, and the stamping connecting parts 151 and the side covers 15 are integrally formed in a punching manner. During assembling, the left and right side covers 3 buckle left and right sides of the roller shaft mounting base 13 and the tip 14 of the split structure respectively, and the stamping connecting parts 151 are mounted in the stamping mounting groove 16, and are fixedly stamped together.

In such a manner, machining difficulty of the roller shaft seat 1 of the novel automatic roller shaft transmission device of the disclosure is greatly lowered; and meanwhile, the roller shaft mounting base 13 is fixedly stamped with the tip 14 of the split structure through the side covers 15, so that the device is ingenious in structure, easier to assemble and higher in efficiency, more assembly parts and components (such as screws) may be saved, production cost may also be lowered, a greater advantage in market competitiveness may be achieved, and a commercial success may be easier to achieve.

Of course, the state that at least one tip 14 of the front and rear tips 14 forms the split structure with the roller shaft mounting base 13 means that: both the front and rear tips 14 may form a split structure with the roller shaft mounting base 13, and stamping mounting grooves 16 are formed in their bottom surfaces; and correspondingly, the stamping connecting parts 151 are arranged on bottom side edges of front and rear ends of the side covers 3. During assembling, the left and right side covers 3 buckle the left and right sides of the roller shaft mounting base 13 and the two tips 14, and the stamping connecting parts 151 at their front and rear ends are mounted in the stamping mounting grooves 16 of the front and rear tips 14 respectively, and are fixedly stamped together.

The above is the preferred implementation mode of the disclosure, it should be pointed out that those skilled in the art may further make a plurality of improvements and embellishments without departing from the principle of the disclosure, and these improvements and embellishments shall fall within the scope of protection of the disclosure.

1. A automatic roller shaft transmission device, comprising a roller shaft seat (1) and a plurality of roller shafts (2), a roller shaft mounting cavity (11) being formed in an upper surface of the roller shaft seat (1), the roller shafts (2) being mounted in the roller shaft mounting cavity (11) in a rotating manner, bearing recesses (12) being formed in a sidewall, corresponding to left and right ends of each roller shaft (2), of the roller shaft mounting cavity (11), and rotating shafts (21) at the left and right ends of the roller shafts (2) being movably mounted in the bearing recesses (12), wherein the roller shaft seat (1) comprises a roller shaft mounting base (13), front and rear tips (14) and left and right side covers (15), the roller shaft mounting cavity (11) is formed in an upper surface of the roller shaft mounting base (13), the front and rear tips (14) are arranged at front and rear ends of the roller shaft mounting base (13) respectively, at least one tip (14) forms a split structure with the roller shaft mounting base (13), a stamping mounting groove (16) is formed in its bottom surface, and is stamping connecting parts (151) are arranged at corresponding positions of the side covers (15); and during assembling, the left and right side covers (3) buckle left and right sides of the roller shaft mounting base (13) and the tip (14) of the split structure respectively, and the stamping connecting parts (151) are mounted in the stamping mounting groove (16), and are fixedly stamped together.

2. The automatic roller shaft transmission device according to claim 1, wherein both the front and rear tips (14) form a split structure with the roller shaft mounting base (13), and stamping mounting grooves (16) are formed in their bottom surfaces; correspondingly, the stamping connecting parts (151) are arranged on bottom side edges of front and rear ends of the side covers (3); and during assembling, the left and right side covers (3) buckle the left and right sides of the roller shaft mounting base (13) and the two tips (14), and the stamping connecting parts (151) at their front and rear ends are mounted in the stamping mounting grooves (16) of the front and rear tips (14) respectively, and are fixedly stamped together.

3. The automatic roller shaft transmission device according to claim 2, wherein the stamping connecting parts (151) are flaky, and horizontally extend after being upwards bent.

4. The automatic roller shaft transmission device according to claim 3, wherein the side covers (15) are metal covers, and the stamping connecting parts (151) and the side covers (15) are integrally formed in a punching manner.
